(19) United States
(12) Patent Application Publication
(10) Pub. No.: US 2010/0251971 A1
(43) Pub. Date: Oct. 7, 2010

(54) Pet Leash and Rope Used Therein

(76) Inventor: Yu-Chen Hsieh, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/419,353

(22) Filed: Apr. 7, 2009

(51) Int. Cl. A01K 27/00

(52) U.S. Cl. 119/798

(57) ABSTRACT

A pet leash includes a connector, a handle, and a rope. The connector is for connecting with a collar; the handle is for being held; and the rope connecting with the connector and the handle by two ends respectively. The pet leash is characterized in that the rope includes a plurality of strands forming a core of the rope and a sheath wrapping and binding up the said core, with the strands being of an elastic material. Therefore, the present invention can avoid a widen crack or sudden snap derived from an initially formed crack while providing a high elasticity.

### BACKGROUND OF THE INVENTION

1. Field of the Invention

The present invention relates to a pet leash and, more particularly, to a pet leash with structure-enhanced design.

2. Description of the Related Art

A conventional pet leash published in Taiwan Patent No. M267846 and entitled “Improved pet leash with collars” is a leash with a mono-core rope and two buckles. Two ends of the rope are entwined and go through the two buckles respectively to form two collars at the said two ends, and sizes of the collars are adjustable by changing positions of the buckles relative to the rope. Hence, one of the collars can be put around the neck of a pet, and the other one can be used as a handle for being held or encircle the wrist of a user. Furthermore, changes in positions of the buckles can also adjust a total length of the pet leash.

However, owing to the fixed length of the rope, the pet leash will be shorten when it is applied to a pet in huge size or its collar is put around other parts of the pet's body, such as the chest thereof, and the shorten leash may lead to inconvenience in use for a tall user. Moreover, the rope is usually selected from materials with low elasticity, which is unable to correspondingly stretch when the pet pulls forwards. Besides, because of the mono-core rope in use, a strong pulling force due to an abrupt jump or leap can not be divided into several parts, which may lead to a widen crack or sudden snap when any crack is initially formed in the rope.

Another conventional pet leash shown in Taiwan Patent No. M280648, entitled “pet leash”, discloses a dual core design that can share pulling force caused by an abrupt motion of a pet. However, in order to make the dual core design through a single rope, a specific device with a complicated structure, named “eccentric limiter”, is needed to selectively fix the total length of the pet leash. Thus, not only a manufacture cost but also complexity of the pet leash is high. Besides, the rope is still made of materials with low elasticity and can not cushion an effect of a sudden pulling, so that a good possibility of breakdown or snap still exists. Hence, there is a need for an improvement over the conventional pet leash.

### SUMMARY OF THE INVENTION

It is therefore the primary objective of this invention to provide a pet leash with an enhanced structure for preventing the pet leash from a snap as well as increasing a lifetime thereof.

A pet leash according to one aspect of the present invention includes a connector, a handle, and a rope. The connector is for connecting with a collar; the handle is for being held; and the rope connecting with the connector and the handle by two ends respectively. The pet leash is characterized in that the rope includes a plurality of strands forming a core of the rope and a sheath wrapping and binding up the said core, with the strands being of an elastic material. Therefore, the present invention can avoid a widen crack or sudden snap derived from an initially formed crack while providing a high elasticity.

In an example, each of the connector and handle has a linking ring, and each end of the rope passes through one of the linking ring and folds up to form a limit ring encircling a side of the linking ring, with folded parts of the rope being fixed.

In a further example, for each end of the rope, a fixing member is arranged at the folded parts of the rope to fix the said folded parts.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view illustrating a preferable embodiment of a pet leash of the present invention;

FIG. 2 is a partial, perspective view illustrating a rope of the preferable embodiment of the present invention; and

FIG. 3 is a partial, sectional view illustrating a connection between a linking ring and an end of the rope of the preferable embodiment of the present invention.

In the various figures of the drawings, the same numerals designate the same or similar parts. Furthermore, when the term “forwards” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

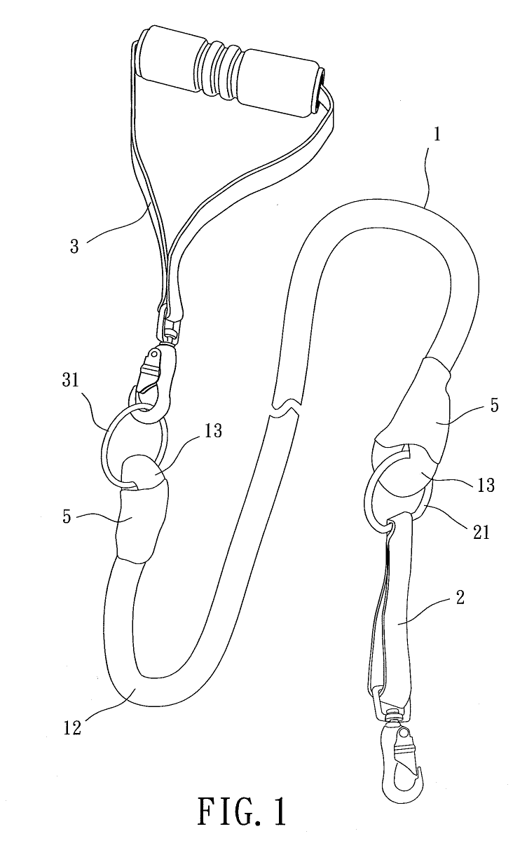

FIG. 1 illustrates a preferable embodiment of a pet leash of the present invention, which includes a rope 1, a connector 2, and a handle 3. Two ends of the rope 1 connect with the connector 2 and the handle 3 respectively, with the connector 2 able to connect with a collar and the handle 3 being for a user to hold.

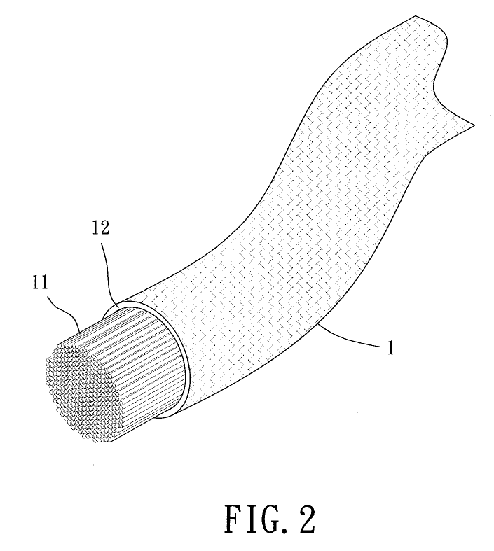

Referring to FIGS. 1 and 2, the rope 1 includes a plurality of strands 11 forming a core of the rope 1 and a sheath 12 wrapping the said core. Each of the strands 11 has an initial length and is made of an elastic material, such as rubber preferably, so as to provide good performances in stretch and shrink. The sheath 12 rigidly wraps and binds up the said core, that is, the strands 11, such that the strands 11 inside the sheath 12 are not loosely stuffed up but tightly arranged to provide an enhanced hardness and structural strength. Moreover, the sheath 12 is preferably in a braided structure formed by yarn for the rope 1 to easily stretch when an outer force is applied. Specifically, because of the structure of the core formed by the plural strands 11, only several of them will snap or be rent when an abrupt pulling force is applied to the rope 1. Namely, damage of the core is effectively limited and expands no more, and thus hurts to a pet or the user caused by sudden snap of the rope 1 are prevented while longevity of the rope 1 is enlarged. Besides, the strands 11 of the elastic material can also provide a buffer effect to prevent the pet from getting hurt due to an abrupt jump or leap.

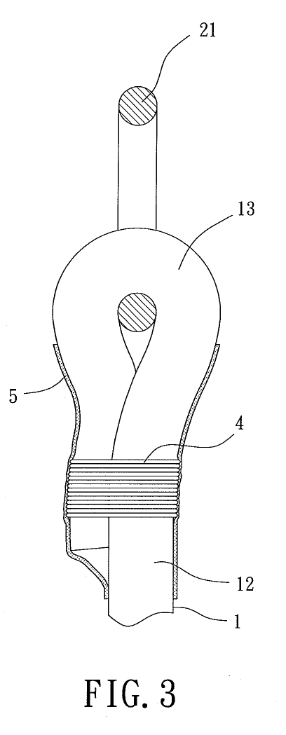

Now turning to FIGS. 1 and 3, the connector 2 has a linking ring 21 and a hook at two opposite ends, with the hook being used for connecting with the collar around the pet's neck, and the handle 3 also has a linking ring 31 at a side. Thereby, two ends of the rope 1 respectively engage with the connector 2 and handle 3 through the linking rings 21, 31, so that the user can control the movement of the pet by holding the handle 3. In detail, one end of the rope 1 passes through the linking ring 21 and folds up to form a limit ring 13 encircling a side of the linking ring 21, with a fixing member 4 arranged at and fixing or tightly binding up folded parts of the rope 1. Accordingly, the linking ring 21 is rotatably coupled with the limit ring 13 and fixed to the rope 1. Similarly, the linking ring 31 of the handle 3 is also fixed to the rope 1 by the same way. Consequently, the pet leash of the present invention is convenient for mass production and also reduces a manufacture cost. Moreover, the fixing member 4 is selected from a cable tie, a fixing wire, or a rivet, and is preferably the fixing wire. For protecting the fixing member 4 from damage and humidity and further binding the said folded parts tightly, a wrap film 5 wraps the fixing member 4 as well as the folded parts of the rope 1.

As has been discussed above, based on the design of the core of the rope 1, which is formed by the plural strands 11, a widen crack or sudden snap derived from an initially formed crack is avoided, and thus the breakdown possibility of the present pet leash is low. Besides, the strands 11 of the elastic material can provide a stretchability of the rope 1 and a buffer effect to prevent the pet or user from getting hurt due to an abrupt motion of the pet.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A pet leash, comprising:
a connector for connecting with a collar;
a handle for being held; and
a rope connecting with the connector and the handle by two ends respectively,
wherein the rope includes a plurality of strands forming a core of the rope and a sheath wrapping and binding up the said core, with the strands being of an elastic material.

2. The pet leash as defined in claim 1, wherein each of the connector and handle has a linking ring, and each end of the rope passes through one of the linking ring and folds up to form a limit ring encircling a side of the linking ring, with folded parts of the rope being fixed.

3. The pet leash as defined in claim 2, wherein, for each end of the rope, a fixing member is arranged at the folded parts of the rope to fix the said folded parts.

4. The pet leash as defined in claim 3, wherein, for each end of the rope, a wrap film wraps the fixing member.

5. The pet leash as defined in claim 1, wherein the sheath is in a braided structure.

6. A rope of pet leash, including:
a plurality of strands being of an elastic material and having an initial length;
a sheath wrapping and binding up the plurality of strands tightly.

7. The pet leash as defined in claim 6, wherein the elastic material is rubber.

8. The pet leash as defined in claim 6, wherein the sheath is in a braided structure.
